(19) United States
(12) Patent Application Publication
(10) Pub. No.: US 2007/0090653 A1
(43) Pub. Date: Apr. 26, 2007

(54) Hover Installed Renewable Energy Tower

(76) Inventor: David R. Martelon, Denver, CO (US)

Correspondence Address: SHERIDAN ROSS PC, 1560 BROADWAY, SUITE 1200, DENVER, CO, 80202, US

(21) Appl. No.: 11/538,798

(22) Filed: Oct. 4, 2006

Related U.S. Application Data
(60) Provisional application No. 60/723,816, filed on Oct. 4, 2005.

(51) Int. Cl. F03D 9/00

(52) U.S. Cl. 290/55

(57) ABSTRACT

The invention provides a scaleable tower that adapts to the technologies of photovoltaic panels and micro to small turbine(s), in multiple configurations, raised in a hover-up manner.

### CROSS REFERENCE TO RELATED APPLICATION

This application claims the benefit of priority under 35 U.S.C. § 119(e) to U.S. Provisional Patent Application Ser. No. 60/723,816 filed Oct. 4, 2005, which is incorporated herein by reference.

### FIELD OF THE INVENTION

The invention relates to a tower that supports multiple configurations of renewable energy components and an improved system of installation. The tower and the configurations supported are particularly suited to systems for the residential consumer market.

### BACKGROUND OF THE INVENTION

The individual technologies of photovoltaic and micro to small turbines have been steadily improving over the course of the last twenty years. The improvements in output and efficiency of these technologies, combined with an increase in manufacturer competition and a decrease in the cost of production due to process improvements, has yielded a much lower consumer cost. This, when coupled with the crossing trends of an increase in utility and government subsidies and an increase in the cost of traditional fossil-based offerings derived from coal-fired or natural gas production plant technologies, has made alternative energies such as solar and wind an increasingly viable choice for receiving energy from utility grids. Projections from multiple sources call for these crossing trends to continue, only making the adoption of alternative energy systems more imminent.

Photovoltaic arrays are typically mounted in either a top-of-roof or top-of-pole configuration. The majority of urban residential or commercial installations use top-of-roof array racks, which allow for large output systems and whose methods of installation are well known. Many residences lack the potential for employing solar energy in this traditional form because they lack an adequate sun-exposure facing roof surface or natural landscape elements that prevent adequate sun exposure. For these, and remote homes with more physical acreage, there is the increasingly common installation technique of a top-of-pole mounted array. Top-of-pole mounted arrays often suffer space and aesthetic challenges as they are composed of a very large solar platform, thereby requiring additional cost and expertise related to raising a large platform.

Wind turbine towers that employ various devices for securing and raising the turbines are known in the art. These previous turbine towers fall into two categories: freestanding or guyed. A freestanding tower does not require any supporting wires to keep it secured from the natural forces of gravity and wind. Freestanding towers have historically utilized either a latticed, pyramid construction or are limited to a much lower elevation. A guyed tower employs a number of support wires that extend out to form a larger base or foundation.

Freestanding, latticed towers are constructed in pieces and a wind turbine is finally secured to the top of the tower with the use of a crane or lift. Both freestanding and guyed towers are raised using a tilt-up methodology, wherein a secure point is established with the use of a crane or lift. In the case of remotely assembled towers, the tower is tilted up into place using rope assemblies. Both of these methods require a high cost, skill and necessitate access to heavier equipment. These requirements lead to market limitations, add significantly to project risk and the need for very specific installation expertise.

### SUMMARY OF THE INVENTION

This disclosure provides highly adaptable renewable energy towers that support multiple configurations of photovoltaic and wind turbine components and an improved system of installing the towers. Further, the same installation mechanics are used to allow an increase in height of the central support tower and, therefore, the tower as a whole.

The adaptability of the towers of the present invention comes into play in regional, or other markets where there is obvious weighted consideration to one or the other technologies of solar or wind. For example, in the sunbelt states it may be advantageous to adapt the tower to augment it with additional photovoltaic panels instead of installing the wind turbine. Conversely, where sunlight is not as prevalent it is possible to install one or more wind turbines and avoid the cost of solar panel installations.

Additionally, tinker-toy construction of the towers allows for enhancement or upgrade of individual pieces without a complete replacement. For example, as photovoltaic and/or turbine technologies improve, it is possible to exchange these individual components with product upgrades to gain an increase in output efficiency without reconstructing the entire renewable energy tower. Another way that output can be maximized is by easily adapting the product to the various tracker technologies that exist in the market, allowing for a number of freestanding solar panels that can track the path of the sun, enhancing the solar input and resultant output.

These towers can also be adapted to a stand-alone or remote site with the optional addition of an enclosure to house the renewable energy system components. This component group can be as complex as a DC disconnect switch, a charge controller, a small battery array, an inverter and an AC disconnect switch or as simple as a subset of these components.

The hybrid nature of the renewable energy towers of the present invention provides a complementarity in that each of the individual component types work together to compensate one for the other. Typically, when the sun is not shining, the wind is operating at or near maximum capacity. This trend is most evident from season to season, which allows for a consistent expectation of year round renewable energy production.

The invention also provides a fundamental improvement in how wind turbines and photovoltaic arrays are raised. The towers of the present invention provide a hover-up installation improvement. This levitation technique allows all component integration to occur at ground level alleviating the installer of difficult elevated integrations or manipulations. Together, these installation improvements significantly reduce the risk, cost and technical knowledge necessary with traditional installations of elevated components. This hover-up installation technique also enables the easy installation of towers with increased height.

Using the installation techniques of the present invention, the selected component parts are assembled on the ground and smoothly pivoted into their raised position. The elevated components are then pivoted into place and secured. The selected outer shell configuration is installed and the photovoltaic panel platform is raised as applicable. All electrical wires are consolidated in the embedded maintenance panel and integrated with the remainder of the renewable energy system components.

By simply reversing the installation process it is easy to upgrade and maintain the components on the tower, which is a common need in the case of micro or small turbines.

Prior art devices are typically limited in height to roughly forty feet by the structural aspects of the inner support beam. But because wind applications increase on a better than linear curve with an increase in height, elevation above forty feet is beneficial for the use of wind turbines. In order to allow for an increase in height while remaining freestanding or non-guyed, a further installation enhancement is provided in this disclosure. With the amendment of an external hover track to the existing inner support beam, it is possible to use a first, manually-installed inner support beam to install a replicated version of that beam as an adjoining outer shell. In this way, it is possible to continue to add additional layers of inner support, thus allowing for an increase in height of the tower as a whole.

This outer replicated shell is raised with the identical mechanics as the hover inset, only along an external track of the inner support tower. The only difference is the pivot stubs on the replicated outer tower are designed to perform a final lower into place upon installation and a lift out of place upon breakdown. This allows the replicated outer tower to drop into place on its foundation lag bolts in order to secure it into place. Finally, the hover inset is hovered past the top of the inner support tower, which is now fully slotted, to the top of the replicated outer tower and pivoted into place. With this additional replicated layer the height of the tower is virtually doubled while maintaining the structural and aesthetic considerations of the tower.

### BRIEF DESCRIPTION OF THE DRAWINGS

FIG. 1a shows the cement foundation from a top viewpoint.

FIG. 1b shows the same foundation pad from a front viewpoint.

FIG. 1c shows the same foundation pad from a side viewpoint.

FIG. 2 shows a perspective of the inner support tower, with an enlargement highlighting the embedded hover track.

FIG. 3a shows the addition of the inner support tower from a side viewpoint.

FIG. 3b shows the installed inner support tower from a front viewpoint.

FIG. 4 shows the hover inset, with an enlargement illustrating the hover-up components.

FIG. 5 shows the addition of the telescoping turbine poles and the micro or small turbine from a side viewpoint, as well as illustrating the hover installation.

FIG. 6 shows the pivot installation, for completeness.

FIG. 7a shows the addition of the outer finishing shell suspended and unassembled.

FIG. 7b shows the assembled outer finishing shell.

FIG. 8a shows a possible solar platform configuration, additionally illustrating the assembly bracket for integration with the outer finishing shell.

FIG. 8b shows an alternate solar platform configuration.

FIG. 8c shows the fully assembled product from a front viewpoint.

FIG. 9a shows an alternate, tiered, solar-only adaptation from a front viewpoint.

FIG. 9b shows the same solar-only adaptation from a side viewpoint.

FIG. 10 shows an alternate top-of-pole adaptation from a front viewpoint.

FIG. 11 shows an alternate, solar-tracker adaptation from a front viewpoint.

FIG. 12 shows an alternate elevated, solar-only adaptation from a front viewpoint.

FIG. 13 shows an alternate, stand-alone or remote adaptation from a side viewpoint.

FIG. 14 shows an alternate, high wind adaptation from a front viewpoint.

FIG. 15 shows modifications to the inner support tower to accommodate an external hover track.

FIG. 16 shows the replicated outer support tower in assembly.

### DETAILED DESCRIPTION OF THE INVENTION

The present invention is drawn to a renewable energy tower that is adapted to support and positioning of renewable energy components. The towers of the present invention are adaptable to many configurations and components, easy substitution and maintenance of these components, stand-alone operation, hybrid operation of multiple components, simplified and inexpensive installation and, optionally, increased height over the related prior art technologies.

The figures that form part of this disclosure are referred to in the following description. The figures show several specific embodiments of the inventive tower technology with integrated renewable energy components. The figures also demonstrate the assembly process, providing a detailed understanding of the components at each layer.

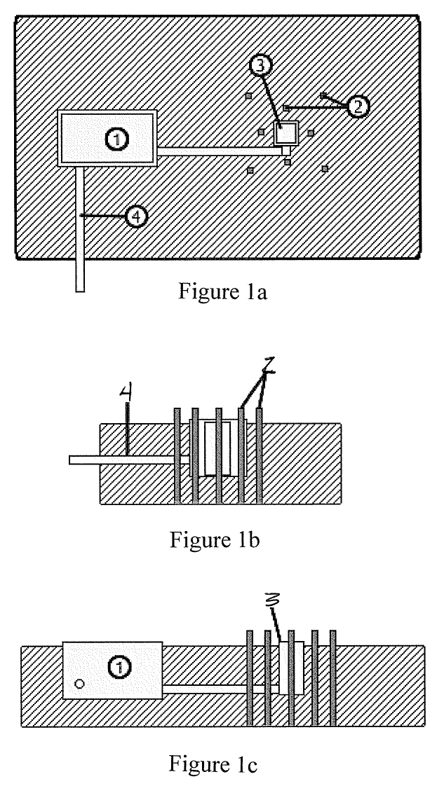

FIG. 1a shows a cement foundation for a renewable energy tower of the present invention from a top viewpoint. The primary function of the foundation pad is structural support and ease of access and maintenance. The individual components of the foundation pad may include an access or maintenance panel (1), anchor bolts (2), an integration junction with the tower assembly (3) and an outlet (4) to optional additional renewable energy system components.

The access or maintenance panel (1) is a housing that allows for ease of installation and future upgrade or maintenance, while protecting the electrical wiring from weather. This ensures that channeling of earth, which is the riskiest and most disruptive part of tower installation, is performed only once. In a preferred embodiment this maintenance panel is a polymer box.

Anchor bolts (2) add to the structural support of the tower, which is important with each increase in height. Preferably, there are two sets of anchor bolts, one set attached to an inner support tower, and another set attached to an adaptable outer finishing shell, described below.

The integration junction with the tower assembly (3) serves the proscribed duty and also adds to the structural stability of the tower. By allowing for countersinking of an inner support tower, the integration junction with the tower assembly increases the integrity and structure of the tower.

The outlet to the additional renewable energy system components (4) is a conduit that feeds wiring to any additional elements of the energy producing system, including, for example, switches, charge controllers, battery array(s), sub-panel(s) and inverters.

FIG. 1b shows the foundation pad of FIG. 1a from a front viewpoint, and FIG. 1c shows the foundation pad of FIGS. 1a and 1b from a side viewpoint.

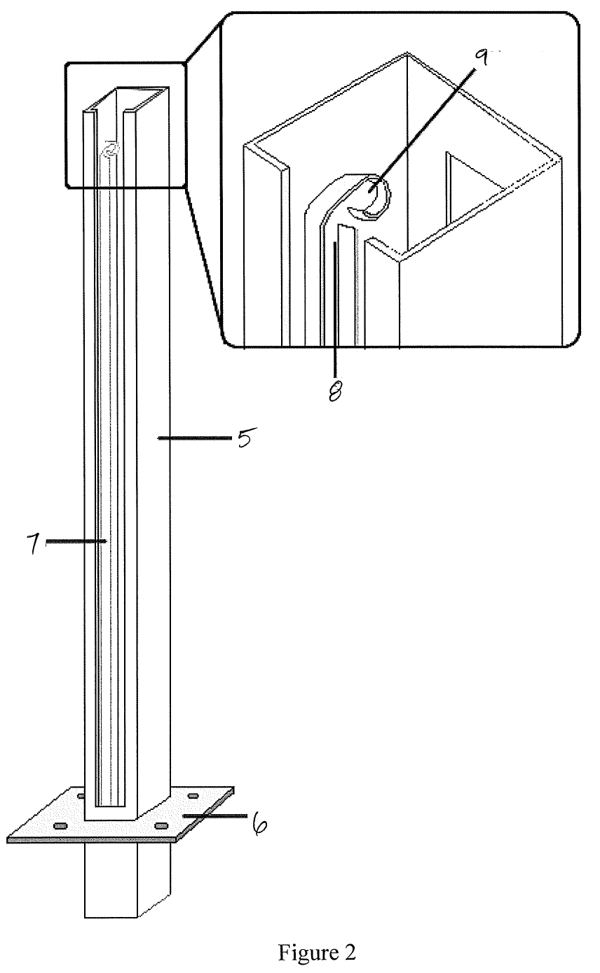

FIG. 2 shows a perspective view of an inner support tower. The inner support tower serves as the core and common structural element of the tower assembly.

The tower beam (5) is preferably milled to facilitate hover installation by allowing free movement of the hover inset and the elevated components. The tower beam is also formed to receive the hover inset to complete the void, thereby adding the necessary structural integrity.

The skirted base support plate (6) forms a skirt around the tower beam (5) at a height that allows for the counter sink of the bottom portion of the tower beam (5) into the concrete foundation for stability and structure. Preferably, the skirted base support plate (6) is a metal piece welded into place around the tower beam (5). The skirted base support plate (6) has holes that match up with anchor bolts in the foundation allowing the tower beam (5) to be secured to the concrete foundation.

The hover track (3) is composed of pieces placed equidistance apart on sides of the tower beam (5), forming a track that guides the hover inset and the elevated components to the top pivot point. The hover track (3) is preferably built of metal pieces welded into the appropriate position to reside equidistant apart on the sides of the tower. The enlargement of the top of the tower beam (5) shows a closer view of the main hover track (8) and the top pivot point (9), which is the final destination of the hover inset.

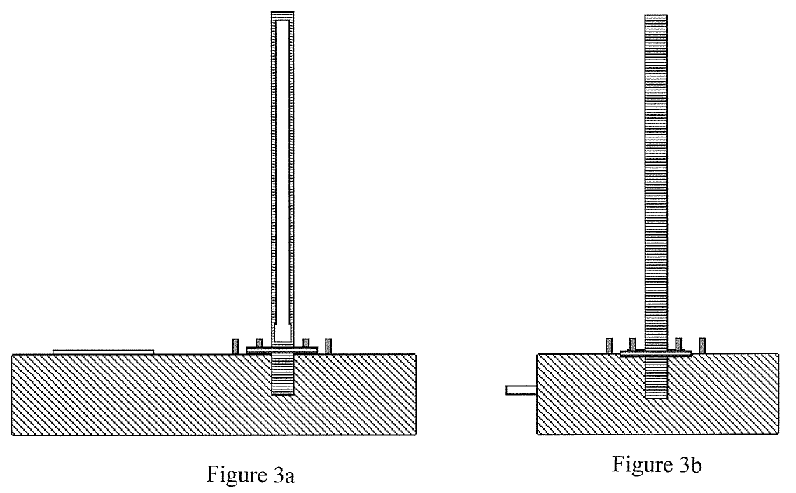

FIG. 3a shows an installed inner support tower from a side viewpoint, and FIG. 3b shows an installed inner support tower from a front viewpoint.

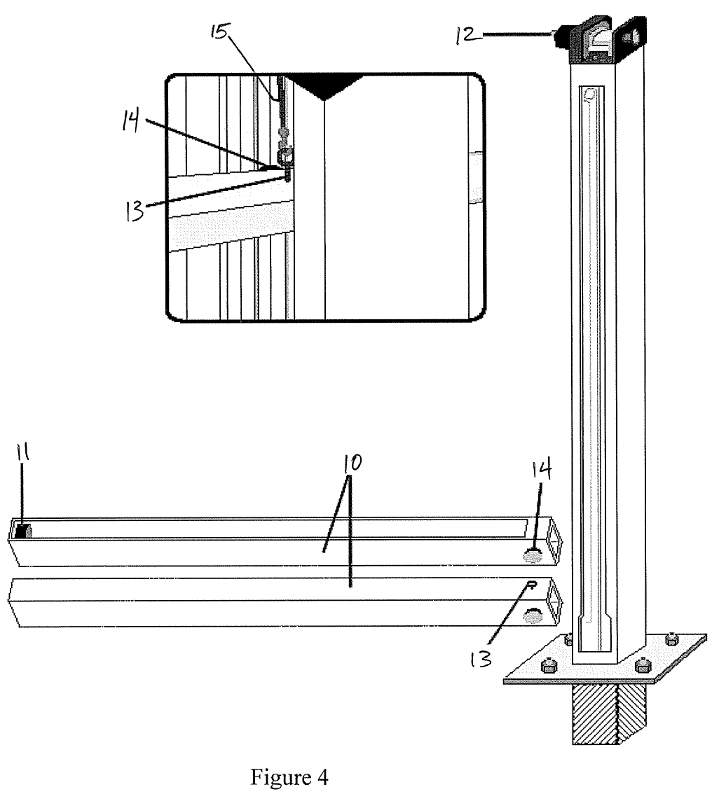

FIG. 4 shows a perspective view of the hover inset tower. The hover inset is composed of the hover inset beam (10), a bottom secure bracket (1 1), a winch (12) and winch loop (13) and hover wheels (14).

The hover inset beam (10) facilitates both the levitation and pivot of the elevated components, by housing, integrating and providing the specialized features that support these functions, described below. Additionally, the hover inset beam (10) fits securely in the void of the inner support tower beam (5, FIG. 2) completing its' structural integrity, and adds the necessary weight to counter balance the elevated components for the ease of the hover and pivot actions.

The bottom secure bracket (11) allows the selected components to be secured to the hover inset beam (10) for the remaining installation of hover and pivot. Telescoping poles of the elevated components may slide onto the bottom secure bracket (11) and are fixed into place.

The hover inset beam (10) is levitated into place using a winch (12) by affixing its' hook to the winch loop (13) on the hover inset beam (10). The winch loop (13) is an eyed loop that receives the hook at the end of the winch cable (15), allowing the hover inset beam (10) to be hoisted and finally set into the pivot point at the top of the hover track.

The hover wheels (14) allow the hover inset beam (10) to smoothly traverse up the hover track of the inner support tower. The hover wheels (14) allow the hover inset beam (10) to levitate to, and set into, the pivot point to prepare the hover inset and the elevated components to be pivoted into place and secured.

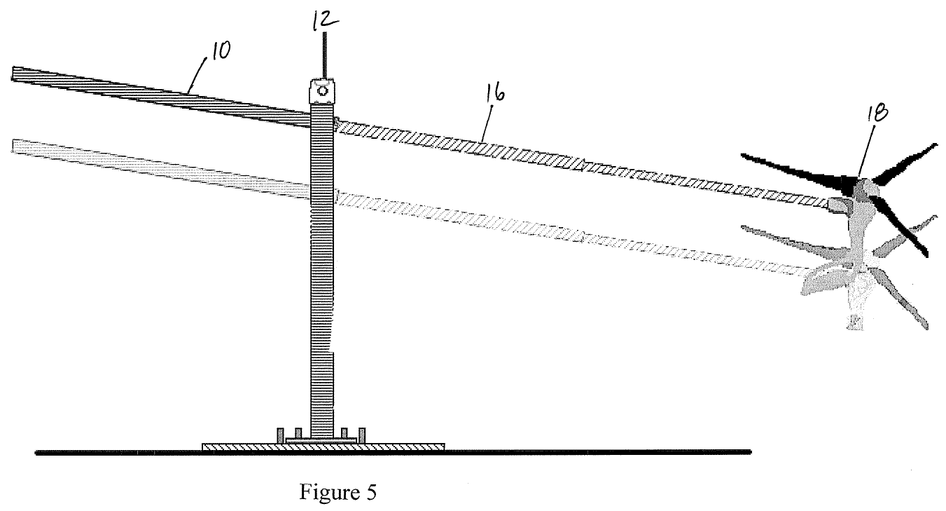

FIG. 5 shows the addition of telescoping turbine poles (17) and a micro or small turbine (18) from a side viewpoint. FIG. 5 shows the winch (12) being used to levitate the hover inset beam (10) and the elevated components to the pivot point.

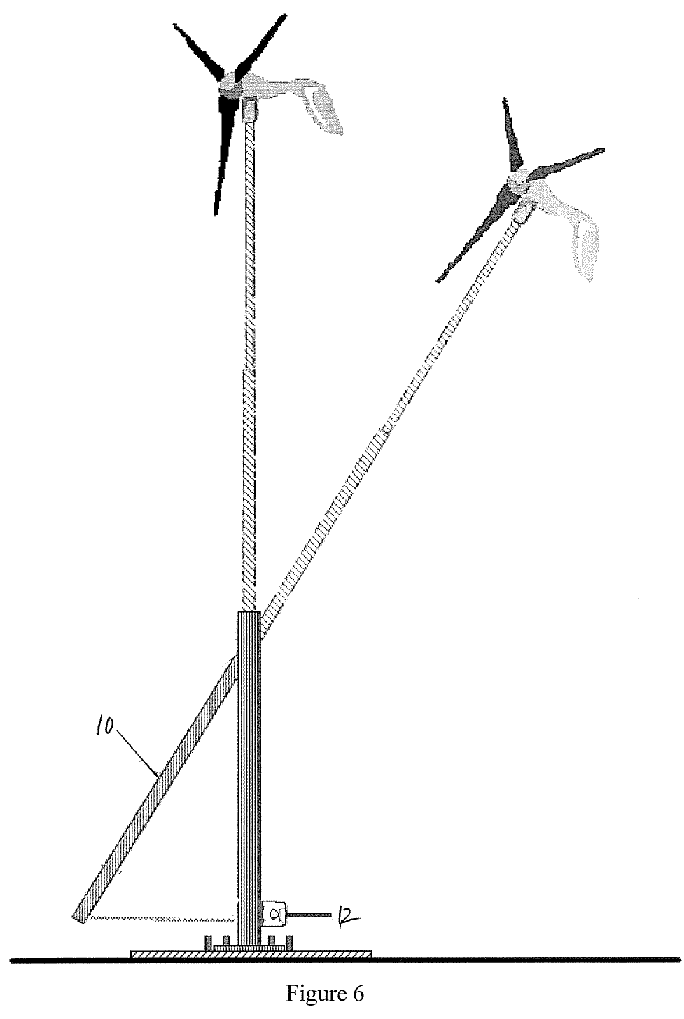

FIG. 6 depicts the pivot installation process. In the pivot installation process the winch (12) has been migrated to allow the hover inset beam (10) and elevated components to be pivoted down into place and finally secured.

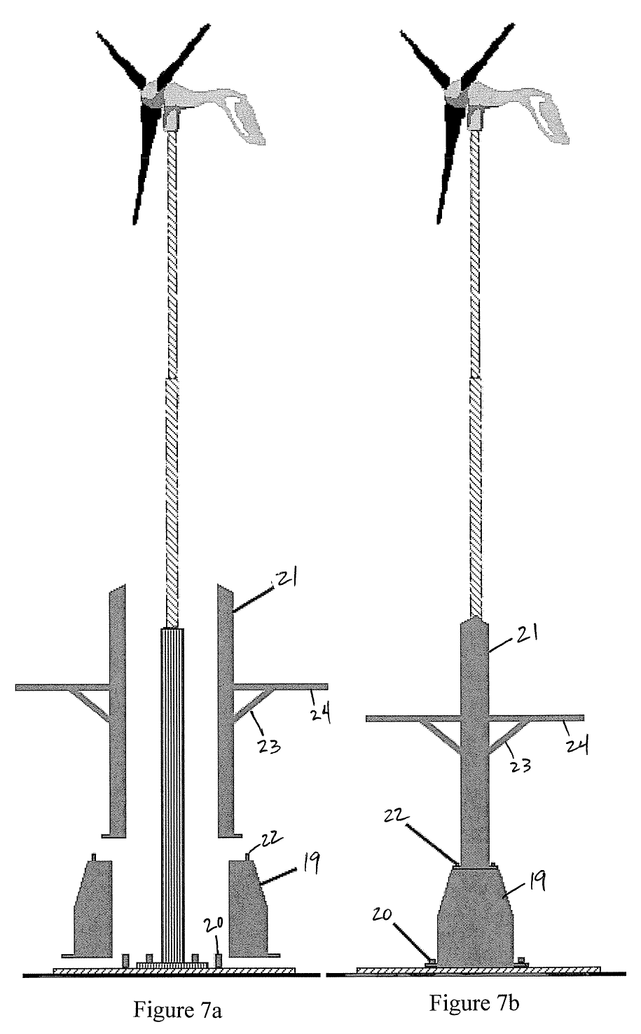

FIG. 7a shows the addition of an adaptable outer finishing shell suspended and unassembled. The outer finishing shell is made up of two sections, an upper section (21) and a lower section (19), each composed of two symmetric parts. The outer finishing shell serves the purpose of a final structural layer and allows the tower to adapt to various configurations without affecting the core and common central components.

The lower section of the outer finishing shell (19) attaches to a foundation via a set of anchor bolts (20). The symmetrical parts of the lower section (19) are then fastened together.

The upper section of the outer finishing shell (21) attaches to the lower section (19) via embedded anchor bolts (22). The symmetrical parts of the upper section are then fastened together. FIG. 7b shows the assembled outer finishing shell. In the adaptation illustrated in FIGS. 7a and 7b, the upper section of the finishing shell (21) includes support poles (23) for the addition of a solar platform (24).

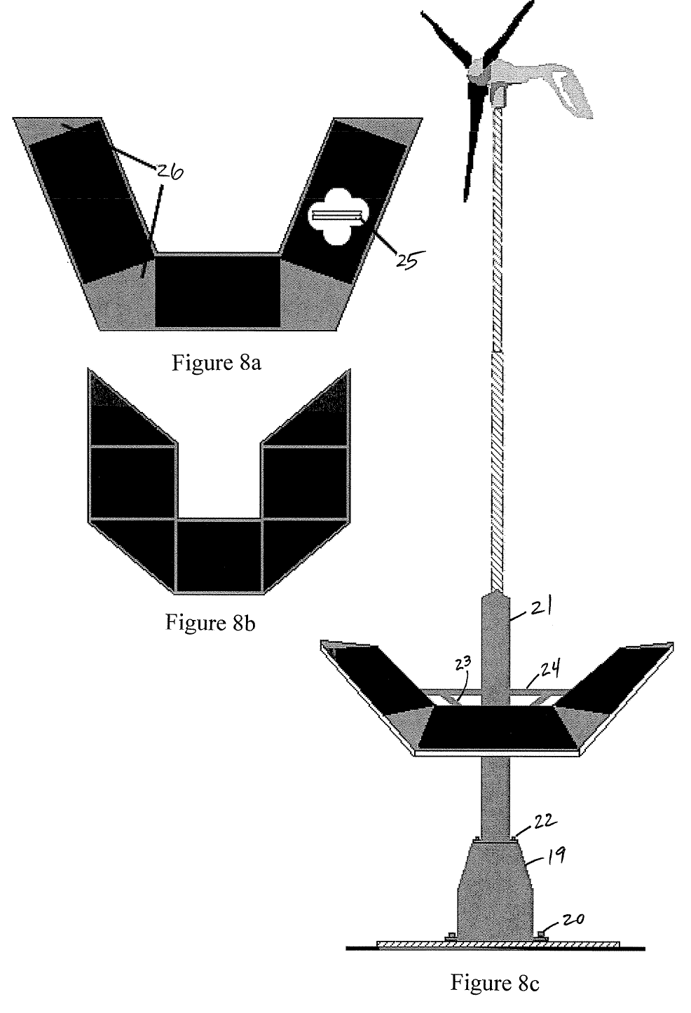

FIG. 8a shows a possible solar platform configuration, including an assembly bracket (25) for integration with the upper section of the outer finishing shell. The assembly bracket (25) may be pre-welded to the solar platform and acts as a female adapter to the support poles of the upper section of the outer finishing shell. The assembly bracket (25) is raised and is married to the support poles and is then rotated to lock it into place. This rotation is also meant to satisfy ease of adjustment for seasonal azimuth considerations. The assembly bracket (25) also allows for the protected integration of wiring from the solar platform to the tower itself. The platform is designed for adaptation to accommodate photovoltaic panels produced by multiple manufacturers by an adjustment to the inset spacers (26).

FIG. 8b shows an alternate solar platform configuration. This illustration demonstrates the adaptation and upgrade that is possible by a simple swap of the solar platform component.

FIG. 8c shows the fully assembled renewable energy tower including a solar platform from a front viewpoint.

The following description illustrates alternate configurations, showing the adaptable nature of the renewable energy towers that allows them to be customized for market regions and individual consumer requirements.

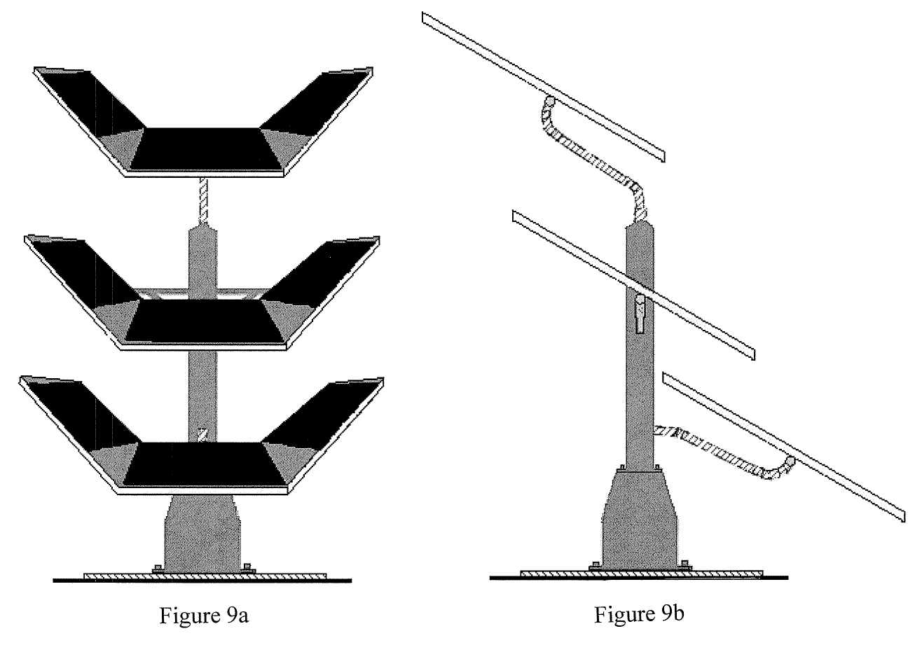

FIG. 9a shows an alternate, tiered, solar-only adaptation from a front viewpoint. With only a modified upper section of the outer finishing shell and an alternate turbine sub-assembly, a solar-only adaptation can be achieved. An optional “footer” solar platform (27) is added to the upper section of the finishing shell (21), which extends the shade plane of the standard solar platform. An additional “header” solar platform (28) is added via the standard hover inset tower (10) via truncated telescoping turbine-like poles and can even be raised by the same hover and pivot methods. FIG. 9b shows the same tiered, solar-only adaptation of FIG. 9a from a side viewpoint.

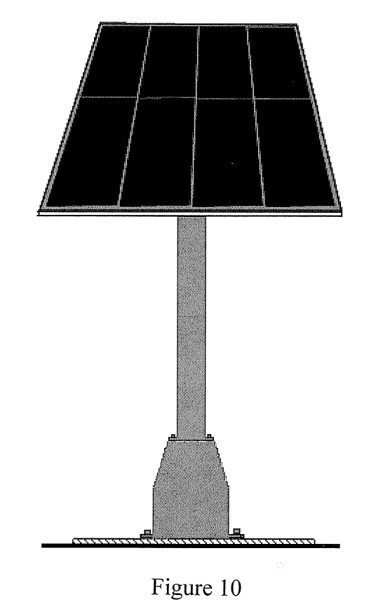

FIG. 10 shows a top-of-pole mount adaptation. The installation of the top array platform is able to take advantage of the same hover and pivot installation improvements previously described, thereby eliminating the need for a crane or lift and operator, as is normally the case. In this scenario, the hover inset and integration pole are assembled and partially levitated into place until the appropriate height, at which the top array platform can be leaned into place and secured. The levitation is completed to the pivot point and the pivot installation raises the platform into place. Securing a finishing shell completes the installation.

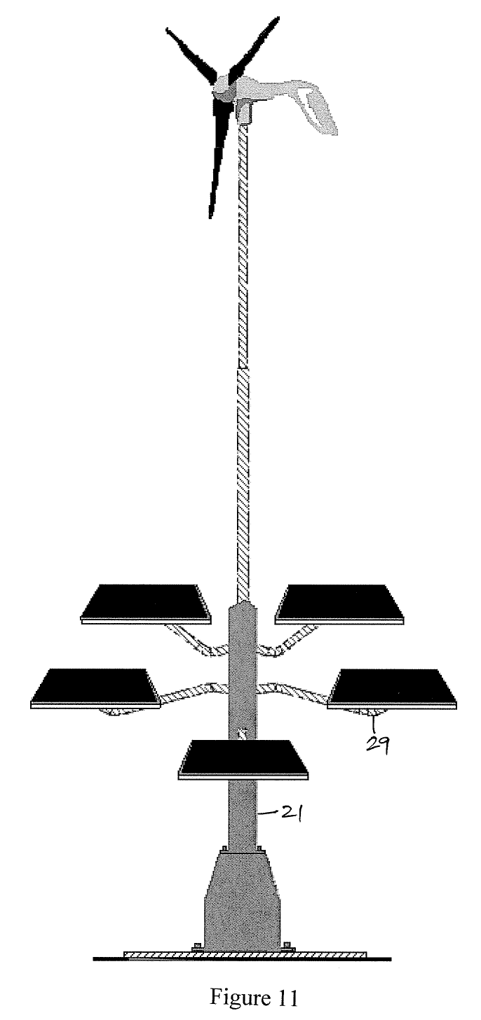

FIG. 11 shows an alternate, solar-tracker adaptation from a front viewpoint. The effectiveness of photovoltaic panels can be maximized by tracker technology. There are two categories of tracker implementations, passive and active. In passive tracker systems, chemical reactions are utilized to tilt a solar panel in the direction of the sun by effectively weighting tracker components. In active tracker systems, sensors are utilized to sample the current maximum angle of input and servomotors, or the like, are used to position the panel accordingly. Both the active and passive methodologies require a freestanding panel configuration in order to allow for the necessary rotation. FIG. 11 depicts an adaptation of the renewable energy tower that fits one such configuration. This solar-tracker adaptation is accomplished by a modification to the upper section of the finishing shell (21) only, adding individual freestanding support poles (29) for the photovoltaic panels.

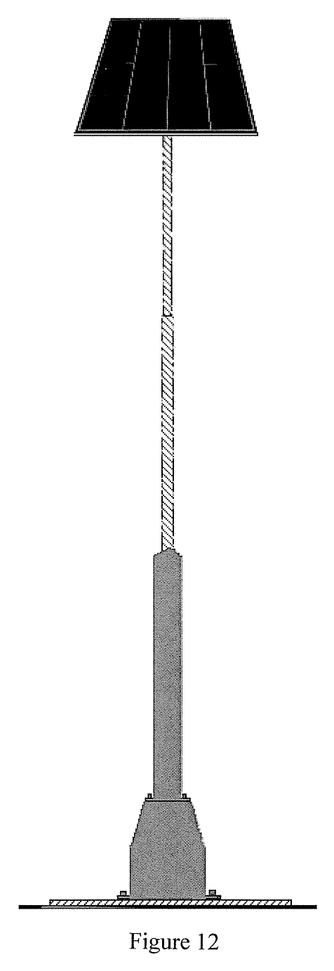

FIG. 12 shows an alternate elevated, solar-only adaptation. This variation may be used to vertically overcome shading challenges, such as trees, in order to maximize sun exposure to generate solar energy.

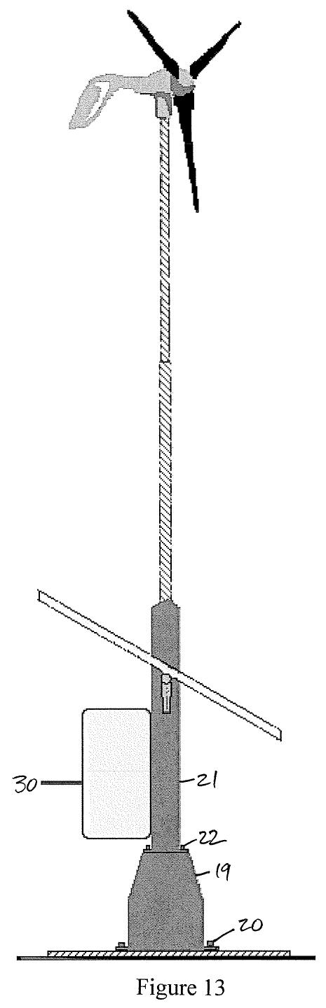

FIG. 13 shows an alternate, stand-alone or remote adaptation from a side viewpoint. This stand-alone adaptation allows for a more tightly integrated renewable energy system consolidating all of the additional system components in an attached enclosure (30). This added enclosure may house components such as switches, a battery array, charge controller and/or inverter to complete the energy producing system, ready to feed remote appliances. The stand-alone adaptation is accomplished by adding the component housing enclosure (30) to the upper section of the finishing shell (21).

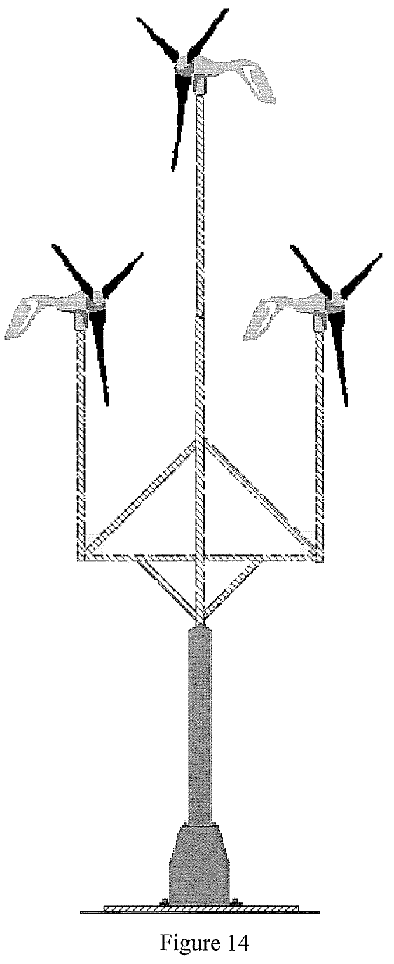

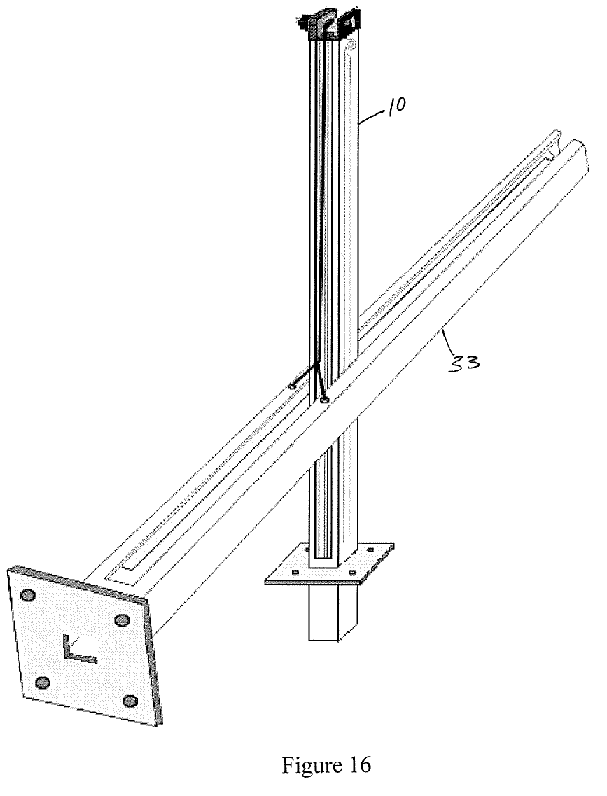

FIG. 14 shows an alternate, high wind adaptation from a front viewpoint. The high wind adaptation shows how multiple turbines could be accommodated with a modification to the turbine sub-assembly. This adaptation would require taking advantage of the replication mechanics (illustrated in FIG. 16) in order to maximize the generating capacity with height, while maintaining the necessary spacing between turbines to keep the turbine manufacturer warrantees in effect.

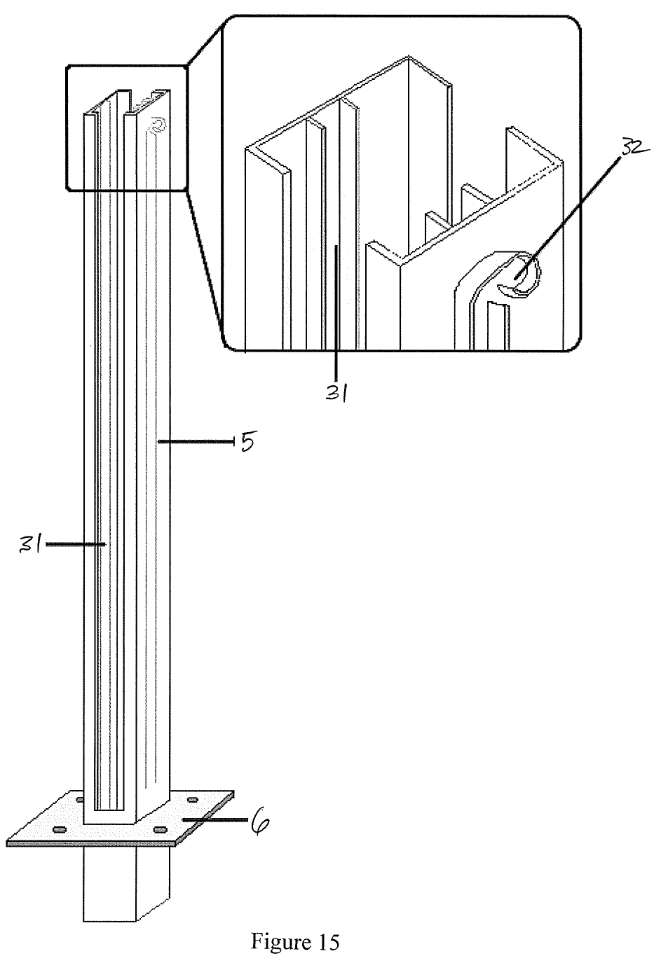

FIG. 15 illustrates modifications to the inner support tower. In this embodiment, hover tracks are assembled external to the inner support tower. Similar to the embodiment shown in FIG. 2, this embodiment depicted in FIG. 15 includes a tower beam (5) and a skirted base support plate (6). In contrast however, this embodiment includes internal tracks (31) and an external hover track pivot point (32). In this embodiment, the outer support tower is assembled to the external hover tracks.

FIG. 16 depicts the mechanics of gaining additional tower height using the same dynamics to replicate the inner support tower (10) with an outer layer (33) that is hovered and pivoted into place resulting in a doubling of the height of the tower.

While the invention has been shown and described with respect to particular embodiments thereof, this is for the purpose of illustration rather than limitation, and other variations and modifications of the specific embodiments herein shown and described will be apparent to those skilled in the art, all within the intended spirit and scope of the invention. Accordingly, this patent is not to be limited in scope and effect, to the specific embodiments shown herein and described, nor in any other way that is inconsistent with the extent to which the progress in the art has been advanced by the invention.

What is claimed is:

1. A support tower for a renewable energy system comprising:
a foundation comprising anchor bolts;
a tower beam containing a hover track composed of linear pieces placed equidistance apart on sides of the tower beam;
a skirted base support plate positioned around the tower beam at a height that allows for counter sink of a bottom portion of the tower beam into a foundation, and having holes that match anchor bolts present in the foundation; and,
a hover inset, comprising:
an inset beam formed to fit inside the tower beam;
a bottom bracket adapted for securing tower components to;
a winch;
a winch cable extending from the winch;
winch loop reversibly attached to the winch through the winch cable; and,
hover wheels adapted to traverse up the hover track of the tower beam.

2. The support tower of claim 1, wherein the hover track comprises a pivot point at one end of the tower beam.

3. The support tower of claim 1, further comprising an outer finishing shell comprising symmetric parts adapted to fit around one end of the tower beam.

4. The support tower of claim 3, wherein the outer finishing shell attaches to the foundation via anchor bolts.

5. The support tower of claim 3, wherein the symmetric parts of the outer finishing shell are fastened together around the tower beam.

6. The support tower of claim 3, further comprising upper finishing shell parts attached to the outer finishing shell via embedded anchor bolts.

7. The support tower of claim 6, wherein the upper finishing shell parts are fastened together.

8. The support tower of claim 1, further comprising at least one renewable energy panel selected from the group consisting of a solar panel and a wind turbine.

9. The support tower of claim 8, wherein the at least one renewable energy panel is a solar panel comprising an assembly bracket adapted to integrate with the upper section of an outer finishing shell comprising symmetric parts adapted to fit around one end of the tower beam.

10. The support tower of claim 8, wherein the at least one renewable energy panel is a wind turbine.

11. The support tower of claim 8, wherein the at least one renewable energy panel is at least one wind turbine and at least one solar panel.

12. The support tower of claim 8, wherein the hover track is attached to internal sides of the tower beam.

13. The support tower of claim 8, wherein the hover track is attached to external sides of the tower beam.

14. A method of erecting a renewable energy tower comprising:
affixing a tower beam to a foundation, wherein the tower beam comprises a hover track composed of linear pieces placed equidistance apart on sides of the tower beam;
providing a hover inset comprising:
an inset beam formed to fit inside the tower beam;
a bottom bracket adapted for securing tower components to;
a winch;
a winch loop attached to the inset beam;
a winch cable extending from the winch and reversibly attached to the winch loop; and,
hover wheels adapted to traverse up the hover track of the tower beam;
guiding the hover inset to the top of the tower beam opposite the foundation under the power of the winch, wherein the hover wheels are guided by the hover track on the tower beam.

15. The method of claim 14, further comprising the steps of:
tilting the inset beam into a vertical position; and,
affixing the inset beam in the vertical position to the tower beam.

16. The method of claim 14, further comprising the step of attaching at least one
renewable energy component selected from the group consisting of a solar panel and
a wind turbine to the inset beam before the step of guiding the hover inset to the top of the tower beam.
